(19) United States
(12) Patent Application Publication
(10) Pub. No.: US 2010/0191674 A1
(43) Pub. Date: Jul. 29, 2010

(54) Method and System for Assessment, Collection, and Disbursement of Funds Related to Motor Vehicles

(76) Inventor: Kevin J. Condon, Truro, MA (US)

Correspondence Address: North Shore Patents, P.C.;Michele Baillie, P.O BOX 683, MARBLEHEAD, MA, 01945, US

(21) Appl. No.: 12/692,689

(22) Filed: Jan. 25, 2010

Related U.S. Application Data
(60) Provisional application No. 61/147,520, filed on Jan. 27, 2009.

(51) Int. Cl. G06F 17/00; G06Q 30/00; G06Q 20/00

(52) U.S. Cl. 705/413

(57) ABSTRACT

The assessment of funds related to motor vehicles includes: receiving a vehicle identification for a motor vehicle from an identification system at a fuel station as part of a fueling transaction; obtaining vehicle information and a funds calculation method from a vehicle assessment database using the vehicle identification, where the funds calculation method comprises variables for the vehicle information; calculating funds to be collected during the fueling transaction using the vehicle information according to the funds calculation method; and determining a total cost of the fueling transaction, the total cost comprising the funds to be collected. Other types of funds or non-fund related functions may be taken into account, such as driver socio-economic data, insurance status data, license status data, fees and fines data, law enforcement data, and data collection for research, analysis, and planning, thus providing a tool for customizing the assessment of funds related to motor vehicles.

### CROSS-REFERENCE TO RELATED APPLICATIONS

The present application claims priority to co-pending U.S. provisional patent application entitled “Efficient Vehicle Assessor (EVA)”, Ser. No. 61/147,520, filed on Jan. 27, 2009.

### BACKGROUND OF THE INVENTION

Federal, state, and local government agencies face challenges in addressing multiple priorities in relation to motor vehicles. These priorities include, but are not limited to: transportation funding; uncollected government revenues; environmental impact of energy consumption; law enforcement; and collection of transportation research data.

Transportation Funding. Currently, the primary source of transportation funding is per-gallon fuel excise taxes. However, as vehicles become more fuel effective they consume fewer gallons of gasoline, thereby reducing the tax revenues necessary to maintain the transportation system. According to current estimates, the revenues collected under the current system equal approximately 40% of the amount necessary to maintain the current transportation infrastructure, not including funding necessary for upgrades and improvements.

Uncollected Government Revenues. Government revenues are currently lost through delinquent parking fines, unregistered vehicles, uninsured vehicles, and unlicensed drivers. In the United States, delinquent parking fines due local governments range from $600 million to $1 billion. Further, an estimated ten percent of all vehicles are unregistered, resulting in millions of dollars in registration fees lost to states. An estimated ten percent of vehicles involved in accidents are not insured, resulting in a huge economic cost to states which fund “no-fault” funds to cover such accidents. In addition, insurance companies pass along costs related to uninsured vehicles to owners of insured vehicles in the form of higher premiums. The total cost to properly insure operators is in the hundreds of millions of dollars.

Environmental Impact of Energy Consumption. There is an international consensus on the need to reduce the use of carbon-based fuels. Automotive and truck fuels account for nearly two thirds of U.S. petroleum consumption. Currently, government relies on a limited number of means to incentivize and manage the fuel efficiency of automobiles and trucks, such as regulations and tax credits. However, the current system is based only on a broad, flat tax per gallon and does not have the capability to apply variable fuel taxes.

Law Enforcement. The current fuel delivery infrastructure is not integrated with law enforcement which is necessary so that identification and apprehension of vehicles are possible in connection with criminal acts.

Collection of Transportation Research Data. Currently, data available for transportation research collection, analysis, and planning purposes are limited. With limited data, comprehensive and targeted policies are difficult to accomplish.

### BRIEF SUMMARY OF THE INVENTION

According to one embodiment of the present invention, a method for assessment of funds related to motor vehicles comprises: receiving a vehicle identification for a motor vehicle from an identification system at a fuel station as part of a fueling transaction; obtaining vehicle information and a funds calculation method from a vehicle assessment database using the vehicle identification, wherein the funds calculation method comprises variables for the vehicle information; calculating funds to be collected during the fueling transaction using the vehicle information according to the funds calculation method; and determining a total cost of the fueling transaction, the total cost comprising the funds to be collected.

In one aspect of the present invention, the method further comprises: receiving the vehicle identification by a vehicle assessment server from the identification system; and performing a query by a vehicle identification module at the vehicle assessment server against the vehicle assessment database, wherein the query by the vehicle identification module returns the vehicle information and the funds calculation method, wherein the funds calculation method comprises the variable for the vehicle information.

In one aspect of the present invention, the method may further comprise: receiving a driver identification for a driver of the motor vehicle by the vehicle assessment server from the identification system; performing a query by a social occupational module of the vehicle assessment server against the vehicle assessment database, wherein the query by the social occupational module returns driver information for the driver identification and the funds calculation method, wherein the funds calculation method further comprises variables for the driver information, wherein the driver information comprises socio-economic data for the driver; and calculating the funds to be collected during the fueling transaction using the vehicle information and the driver information according to the funds calculation method.

In other aspects of the present invention, the funds calculation method may further comprises variables for insurance status data, licensing status data, fees and fines data, or law enforcement status data, where the funds calculation method further comprises variables for the insurance status data, the licensing status data, or fees and fines data, or configuration data for the law enforcement status data.

In one aspect of the present invention, data for the fueling transaction are reported to one or more interested entities.

System and computer program products corresponding to the above-summarized methods are also described and claimed herein.

### BRIEF DESCRIPTION OF THE SEVERAL VIEWS OF THE FIGURES

FIG. 1 illustrates an embodiment of a system for the assessment of funds related to motor vehicles according to the present invention.

FIG. 2 is a flowchart illustrating an embodiment of a method for the assessment of funds related to motor vehicles in accordance with the present invention.

FIG. 3 illustrates in more detail an embodiment of a system for the assessment of funds related to motor vehicles in accordance with the present invention.

FIG. 4 is a flowchart illustrating in more detail an embodiment of a method for the assessment of funds related to motor vehicles in accordance with the present invention.

FIG. 5 illustrates example ways of capturing the vehicle ID.

### DETAILED DESCRIPTION OF THE INVENTION

The present invention provides a method, system, and computer program product for assessment of funds related to motor vehicles. The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

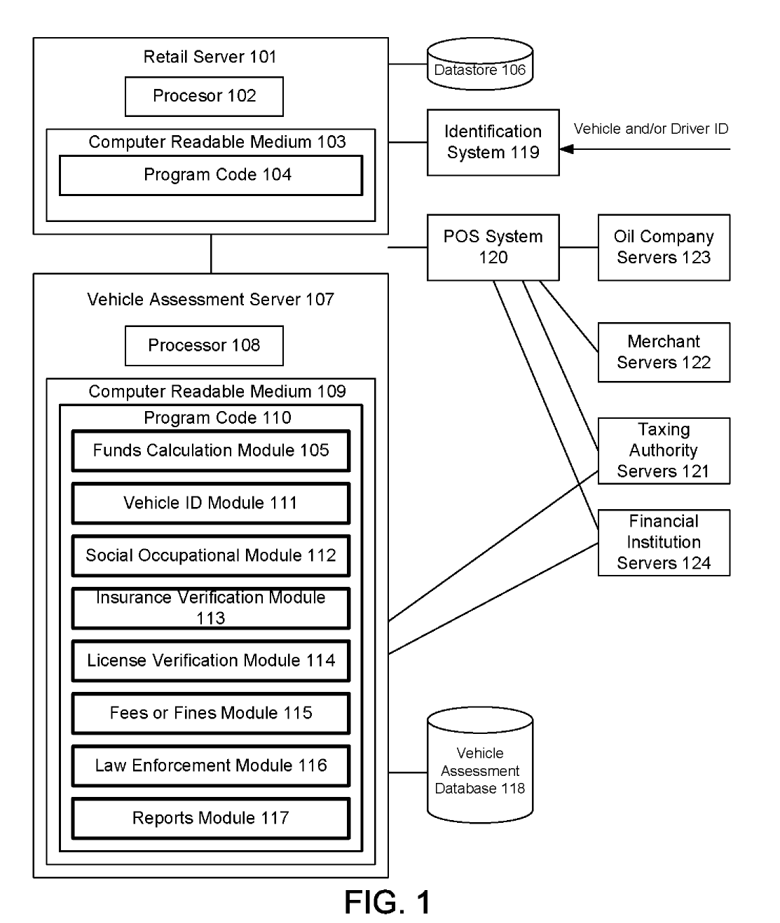

FIG. 1 illustrates an embodiment of a system for the assessment of funds related to motor vehicles according to the present invention. The system includes a retail server 101 and a vehicle assessment server 107. The servers 101, 107 are each operatively coupled to a processor 102, 108 and a computer readable medium 103, 109. Each computer readable medium 103, 109 stores computer readable program code 104, 110 for implementing the method of the present invention. The processors 102, 108 execute the program code 104, 110 to assess, collect, and disburse funds according to the various embodiments of the present invention.

In this embodiment, the program code 110 comprise several functional modules, including a funds calculation module 105, a vehicle identification (ID) module 111, a social occupational module 112, an insurance verification module 113, a license verification module 114, a fees or fines module 115, a law enforcement module 116, and a reports module 117. Optionally, the program code 104 at the retail server 101 may be configured to provide local assessment of funds to be collected in the event the vehicle assessment server 107 is not available. This local assessment of funds can be performed offline or the assessment can be resumed or amended at a later fueling transaction once the vehicle assessment server 107 becomes available. Alternatively, the funds calculation module 105 may be part of the program code 104 at the computer readable medium 103 of the retail server 101. Each module is described further below.

A retail server 101 resides locally at each fueling station and is operatively coupled to a local datastore 106, the vehicle assessment server 107, an identification (ID) system 119, and a point-of-sale (POS) system 120. The POS system 120 is further operatively coupled to entities relevant to the collection and distribution of funds from fueling transactions, such as taxing authority servers 121, merchant servers 122, oil company servers 123, and/or financial institution servers 124. The datastore 106 stores whatever information is required during a fueling transaction. The storage 106 further stores configuration or any other data needed for setup and interface with the POS system 120 and other critical operations. The system further comprises messaging middleware (not shown) to allow connectivity to any number of other systems by employing any combination of various messaging protocols, such as eXtensible Markup Language (XML), application programming interface (API) calls, Structured Query Language (SQL) queries, web services, etc.

The system comprises interface technologies to allow interface with the POS system 120. These technologies may comprise API calls, WEB services and XML file transfers. Custom file transfers are also available to provide ease of data exchange between the system, merchants, and taxing authorities at the local, state, and federal levels.

The vehicle assessment server 107 is operatively coupled to a vehicle assessment database 118, which stores tables containing vehicle ID's matched with vehicle information, as well as any other information required for the functionalities of the system as described below. Examples of vehicle information comprise any combination of make, model, weight, year, fuel efficiency data, etc. Also stored in the database 118 are funds calculation methods for calculating the funds to be collected for a fueling transaction, as described below.

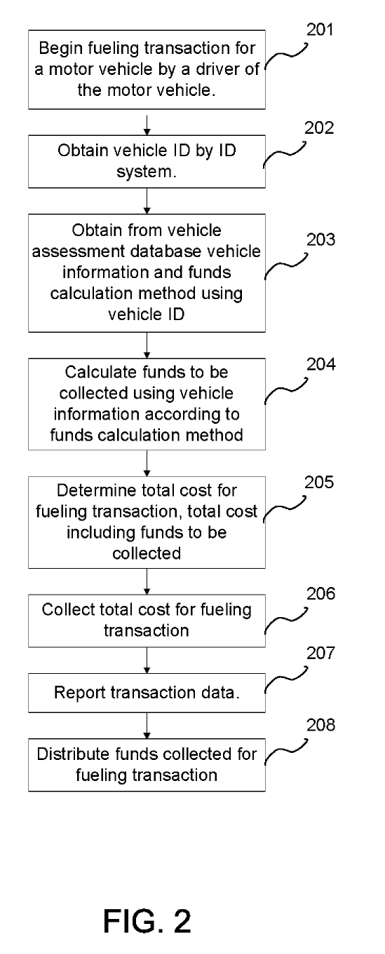

FIG. 2 is a flowchart illustrating an embodiment of a method for the assessment, collection, and disbursement of funds related to motor vehicles in accordance with the present invention. Referring to both FIGS. 1 and 2, a driver of a motor vehicle begins a fueling transaction at a fueling station (201). At this fueling station is a retail server 101. As part of the fueling transaction, the vehicle ID for the motor vehicle is obtained by the ID system 119 (202). The ID system 119 can comprise any number of technologies, including smart cards, scanners, radio frequency identification (RFID) tags, and global positioning system (GPS) tracking devices. Vehicle information is then obtained from the vehicle assessment database 118 using the vehicle ID (203). Also obtained from the vehicle assessment database 118 is a fund calculation method. In this embodiment, the fund calculation method is uploaded to the vehicle assessment server 107, and stored in the vehicle assessment database 118, by the federal, state and/or local taxing authorities. The fund calculation method can be customized to the respective taxing authority's tax policies and rates, as described further below.

In this embodiment, the vehicle ID is passed from the ID system 119 to the vehicle ID module 111 via the retail server 101. The vehicle ID module 111 performs a query against the vehicle assessment database 118, and the vehicle information matched with the vehicle ID is returned. Some vehicle information may also be obtained from the vehicle itself, such as from the vehicle's performance computer.

The vehicle information and fund calculation method are passed to the funds calculation module 105 of the vehicle assessment server 107. The funds calculation module 105 calculates the funds to be collected using the vehicle information according to the fund calculation method and passes the funds to be collected to the POS system 120 via the retail server 101 (204). Optionally, if the vehicle ID is not found in the vehicle assessment database 118, a default tax rate may be used to calculate the funds to be collected. The POS system 120 then determines the total cost for the fueling transaction, where the total cost includes the funds to be collected as well as the cost of the fuel (205). The total cost of the transaction is collected from the driver by the POS system 120 (206). Data for the fueling transaction is passed to the vehicle assessment server 107, which stores the transaction data in the vehicle assessment database 118. The reports module 117 reports the transaction data to interested entitles, such as government authorities (207). In this embodiment, the transaction data may comprise any combination of gallons pumped, excise tax, fees, fines, consumption and payment information, etc. The interested entities can use the transaction data for tracking and research purposes.

Once the funds for the total cost of the fueling transaction is collected from the driver, the POS system 120 distributes the funds to the appropriate entities (208), which may comprise taxing authority servers 121, merchant servers 122, oil company servers 123, and financial institution servers 124. The disbursement of funds to the financial institution servers 124 (such as for credit cards, debit cards, electronic checks, wire transfers, etc.) may be accomplished through the POS system 120, directly between the vehicle assessment server 107 and the financial institution server 124, or a combination of both.

Using the above described system, governmental authorities may define the fund calculation method with variables for the vehicle information to tailor fuel tax assessment to each specific vehicle based on a number of criteria and according to policies. In addition to vehicle information, the fund calculation method can further be defined with variables for the driver information. In this embodiment, the ID system 119 obtains a driver ID as well as the vehicle ID. The driver ID is passed from the ID system 119 to the social occupational module 112 via the retail server 101. The social occupational module 112 performs a query containing the driver ID against the vehicle assessment database 118, and driver information matched with the driver ID is returned. A single query containing both the driver ID and the vehicle ID may be sent to obtain the vehicle information and the driver information, as well as the funds calculation method. In one embodiment, the vehicle assessment database 118 further stores driver ID's matched with driver information. Examples of driver information comprise any combination of socio-economic data (such as those identified or required by certain governing authorities, address, income class, occupation, disability status, veteran status, etc.), insurance data, license data, vehicle inspection and safety data, fines data, fuel tax data, law enforcement/security status, etc. The system provides entities possessing these data to upload the data to the vehicle assessment database 118 or to configure queries to these entities' data sources. Thus, in addition to storing vehicle ID's matched to vehicle information and driver ID's matched to driver information, the vehicle assessment database 118 may comprise any combination of a vehicle registration database, a vehicle insurance database, and a parking fines database, as well as other data relevant to the functionalities of the vehicle assessment server 107.

The variables used in the funds calculation method may be based on any combination of factors that can be captured from the vehicle ID, the driver ID, or retrieved from the vehicle assessment database 118 or third party databases. Such data can be leveraged to provide the underlying data to provide performance based fuel excise tax calculation, fine, and penalty collection and/or denial of fuel access. Each governing authority at the federal, state, and local level can use the vehicle assessment system to customize and target is own fuel tax policies and rates at a much more detailed way, greatly increasing the value of the fuel tax to reward energy efficiency at an individual motorist level, in addition to the vehicular class level. For example, the governmental authorities may decide to tax groups of drivers differently in order to mitigate disparate impacts resulting from changes in tax policies. This may be accomplished by uploading a funds calculation method which takes into account the socio-economic status of drivers contained in the driver information. For example, the geographic information for the driver, such as for rural drivers and long-distance commuters for whom public transit alternatives are limited, may be taken into account. For another example, driver profiles, such as for senior citizens, disabled veterans, and low-income drivers, may be taken into account. Certain occupational classifications may also be taken into account, such as public safety professionals, emergency personnel, and law enforcement personnel.

Similarly, the governmental authorities may decide to tax individual vehicles differently. This may be accomplished by uploading a funds calculation method with variables which takes into account dynamic vehicle data. Example dynamic vehicle data comprises, for example, the vehicle's fuel efficiency during performance over a specified range of time, miles driven during specific parameters such as geographic and temporal variables, and carbon production of individual vehicles during a specified time range of operation. The vehicle assessment server 107 can assess the fuel tax for each fueling transaction tailed to data comprising: country/state of origin (for example, allowing states to assess a lower per gallon tax for vehicles made in the home state or in the home country); vehicle manufacturer; vehicle type, correlated with the established miles per gallon (MPG) rating; vehicle information (such as engine size, body type, fuel type, model, gross vehicle weight, etc.); vehicle model year; assembly plant (for example, allowing tax breaks for those vehicles assembled in the home state); and from the vehicle computer, recent performance data since the last refueling, including mileage, emissions, date of recent performance maintenance (air filters, oil changes, etc.), location and time of vehicle operation (via installed global positioning system (GPS) device) used in coordination with congestion pricing systems employed by the governing authorities. The funds calculation method can thus be designed to apply variable fuel taxes to encourage behaviors needed to achieve fuel-effective behaviors, including incentives to move to more fuel efficient vehicles, such as hybrid and non-gas vehicles. In this manner, an approach that incorporates variable criteria in the assessment of fuel tax, while mitigating the impact on specific categories of drivers and/or vehicles, is accomplished.

For example, assume that policymakers have decided to incentivize fuel efficient behavior through a carbon tax on individual vehicle emissions. Vehicle information obtained by the vehicle ID module 111 as described above may include the number of miles driven or the number of gallons consumed since the last refueling, or any other type of available data relevant to carbon emissions. The estimated carbon emissions per gallon or mile for the vehicle's particular make, module, and age may be obtained from tables in the vehicle assessment database 118 or some third party database outside of the system. A funds calculation method comprising a formula for determining a carbon tax based on this vehicle information would also be obtained. This vehicle information and the funds calculation method are passed to the funds calculation module 105, which in turn uses them to calculate the carbon tax as part of the funds to be collected. Alternatively, the carbon tax assessed can be based on the actual carbon emission for the vehicle, if available. The total cost of the fueling transaction would include this carbon tax as well as any other funds assessed according to the funds calculation method.

In addition to providing a tool for customization of the calculation of tax to be collected, the system of the present invention may also be used to assess other types of funds, as well as for other non-fund related functions. Each of these fund-related and non-fund related functions may be implemented alone or in combination without departing from the spirit and scope of the present invention. Other types of funds include parking fines, insurance fees, licensing fees, and registration fees. Non-fund related functions include verification of insurance, verification of licenses, law enforcement, and data collection for research, analysis, and planning purposes. The following are examples of research data that may be collected using an embodiment of the system of the present invention: determination of actual (rather than estimated) miles per gallon data sortable by vehicle type, age, weight, class, season, and geographic area, and driver profile characteristics such as age and any other socio-economic characteristics; determination of the effect of vehicle age on fuel efficiency, for example to determine which vehicle models maintain fuel efficiency over time; fuel tax revenues by region, location, vehicle type, and time (seasonal, daily, weekly, etc.); up-to-date analysis of relative increase/decline of non-compliant vehicles on the road; aggregate fuel consumption sorted variable including but not limited to those noted above; and any other data as identified by interested entities.

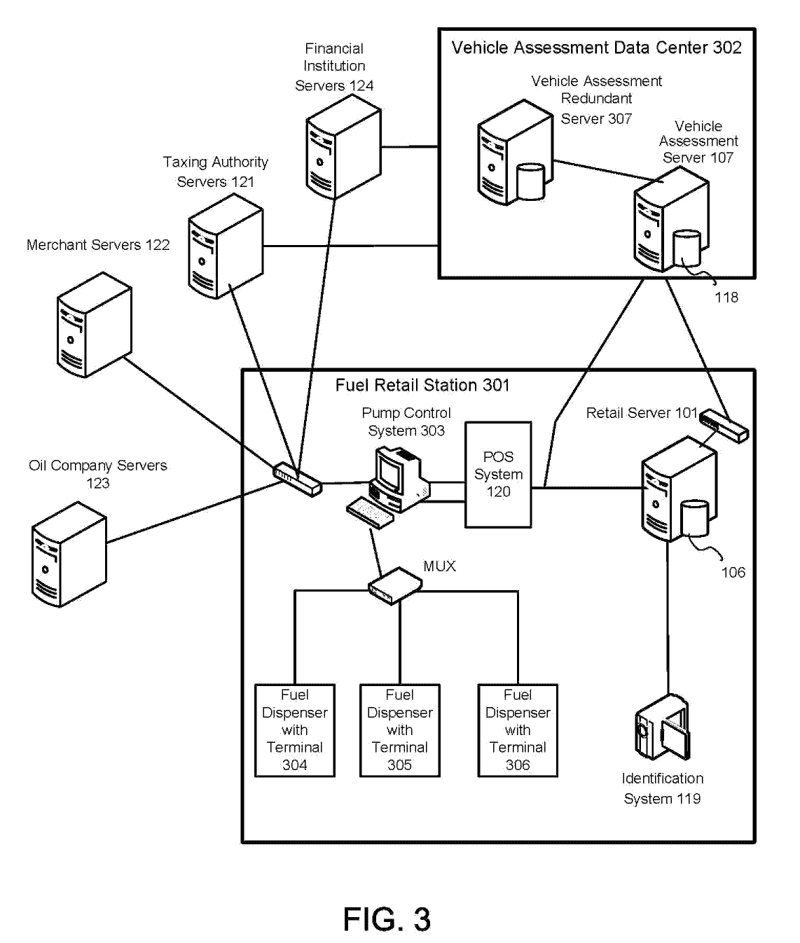

FIG. 3 illustrates in more detail an embodiment of a system for the assessment, collection, and disbursement of funds related to motor vehicles in accordance with the present invention. The system includes the ID system 119 at each fuel retail station 301, and the retail server 101 with communications hardware residing locally at each fuel retail station 301 with interfaces to the POS system 120. The ID system 119 includes one or more readers for obtaining the vehicle ID and/or the driver ID. The system further includes vehicle assessment data center(s) 302 comprising the vehicle assessment server 107, a vehicle assessment redundant server 307 for backup/failover purposes, including communications infrastructure and failover equipment to operatively couple the servers 107 and 307, and the vehicle assessment database 118. The vehicle assessment server 107 comprises the modules as described above with reference to FIG. 1. Each fuel retail station 301 includes a pump control system 303 operatively coupled to the POS system 120 and the fuel dispensers 304-306.

The various components at each fuel retail station 301 communicates with the vehicle assessment server 107, the taxing authority server 121, the merchant transaction server 122, and the oil company servers 123 over one or more messaging interface networks. The messaging interface networks may include hardwired local area network cabling and switches, wireless gateway switches and wireless transmitters, or any other appropriate messaging infrastructure. In this embodiment, messages comprising XML schema including the data message type and the message payload are exchanged between the components of the system, however, any messaging protocol may be used.

For example, the payload of XML messages exchanged between the retail server 101 and the vehicle assessment server 107 may include any combination of a fuel station ID, individual pump ID, vehicle ID, and vehicle information comprising vehicle performance, vehicle characteristics, driver information, legal compliance information, fuel consumption and taxation, fees and fines data. The payload of XML messages exchanged between the vehicle assessment server 107 and the taxing authority server 121 may comprise any combination of fuel station ID, vehicle ID, and vehicle fuel consumption and taxation data. The payload of XML messages exchanged between the vehicle assessment server 107 and the POS system 120 may comprise any combination of an individual pump ID, consumption and taxation, and fees and fines data. Any other relevant data may also be included in the payload of the XML messages. The POS system 120 to merchant server 122 transaction messages may contain vehicle charges and credit card information. The pump control system 303 to oil company servers 123 messages may contain pump filling data and gross taxation data.

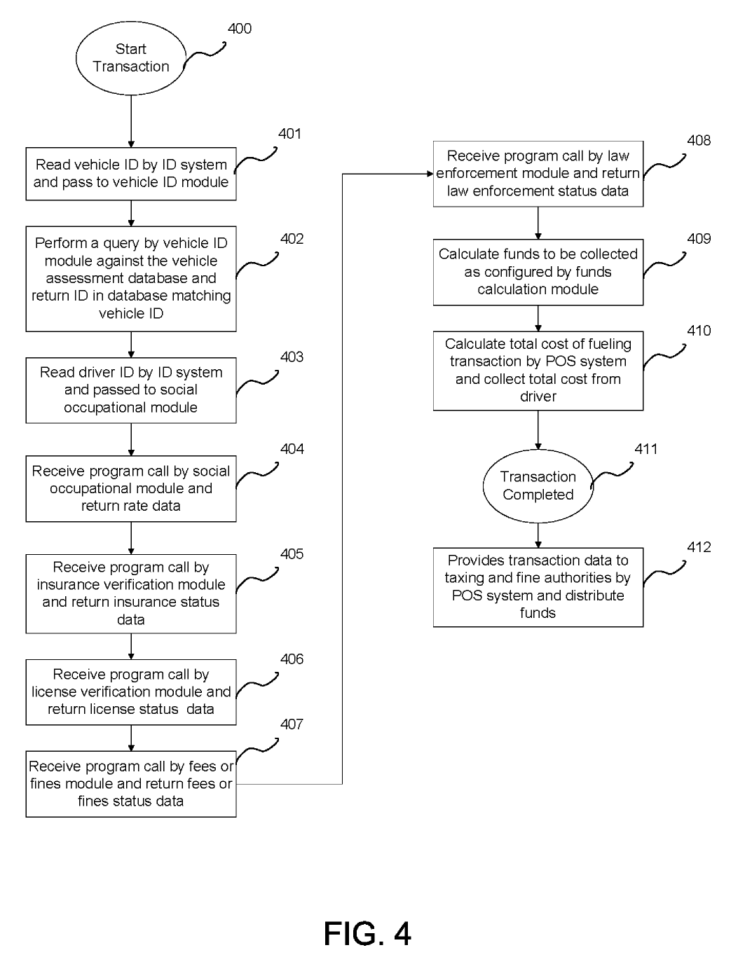

FIG. 4 is a flowchart illustrating in more detail an embodiment of a method for the assessment, collection, and disbursement of funds related to motor vehicles in accordance with the present invention. The process begins with the motor vehicle entering a fuel retail station 301 and with the driver initiating the fueling transaction (400), for example by inserting a payment card at the terminal of a fuel dispenser 304. The vehicle ID for the motor vehicle is read by the ID system 119 and passed to the vehicle ID module 111 via the retail server 101 (401).

The ID system 119 uses application software and data-capture technology to gather information from each vehicle when refueling at the fuel retain station 301. The vehicle ID may be captured using any of a number of capture technologies, depending on the capabilities of the vehicle. For example, if supported, vehicle ID can be automatically captured through use of a RFID. Vehicles with sophisticated onboard computers can be read using wireless RF calls to the computer. For vehicles with less sophisticated computers or with no RFID capability, or for vehicles in locations where devices to capture non-static data is not available, the vehicle ID can be captured through a decal affixed to the vehicle at an assessable location, such as a 2-D barcode, 3-D barcode, a Unique Identification (UID), smart chip, etc. Alternatively, the decal can be affixed to an identification card. Optionally, the vehicle ID may be entered manually by the driver, or if no vehicle ID can be obtained, the funds to be collected may be assessed based on a default tax rate.

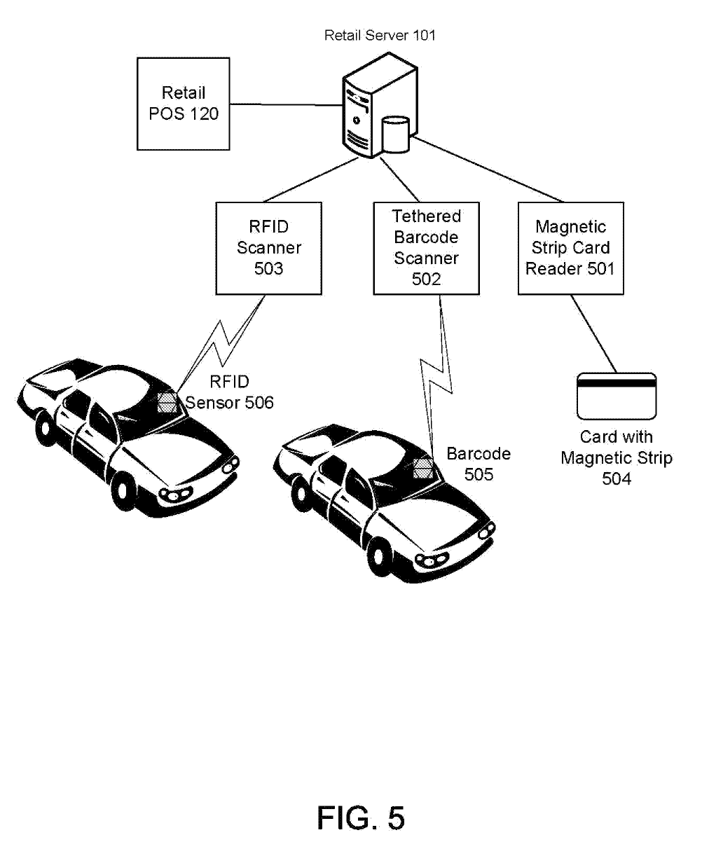

FIG. 5 illustrates example ways of capturing the vehicle ID. One way is a card 504 with a magnetic strip storing the vehicle ID. The card 504 may be a house account card, a debit card, a credit card, or a fleet credit card. The driver inserts the card 504 into a magnetic strip card reader 501 located at the fuel retail station 301 to begin the fueling transaction. Another way is a barcode identification tag 505 storing the vehicle ID. A tethered barcode scanner 502 located at the fuel retail station 301 is used to scan the barcode identification tag 505. To prevent fraudulent use of the barcode 505, once affixed to the vehicle, the barcode 505 cannot be removed. The barcode scanner 502 can be either handheld or positioned to automate the scan. A third technology is a vehicle mounted RFID sensor 506. The RFID sensor 506 can be read using a RFID scanner 503 located at the fuel retail station 301. The RFID tags allow for instant authorization and odometer collection. The RFID tags may also be used to identify vehicle ID, odometer, and vehicle performance data automatically with receives at access points, gates or the pump. The card 504, the barcode identification tag 505, or the RFID sensor 506 may be issued by a government agency through an application process. As intelligent vehicle technology develops, the vehicle assessment system will be able to adapt to capture as much data as there is available.

Returning to FIG. 4, the vehicle ID module 111 performs a query against the vehicle assessment database 118 to match the vehicle ID read by the ID system 119 to a vehicle ID in the vehicle assessment database 118 (402). A match verifies that the vehicle is in the database 118. The query returns a vehicle ID which is used to make calls to the other application modules of the vehicle assessment server 107, including the funds calculation module 105.

Depending on requirements set forth by a governing authority, the driver may or may not be required to scan either a driver's license or a special vehicle assessment identification card. Assume here that the governing authority requires entry of a driver ID. The driver ID is read by the ID system 119 and passed to the social occupational module 112 via the retail server 101 (403). The social occupational module 112 receives a program call and performs a query against the vehicle assessment database 118 to determine if any special rates are to be included in the tax assessment (404). Example data retrieved comprises driver age, disabled veteran status, and occupational status (such as public safety, first responders, and other emergency personnel).

A program call is also made to the insurance verification module 113, where the vehicle ID is passed. The insurance verification module 114 runs a query against the vehicle assessment database 118, and insurance status data is returned (405). The insurance verification module 113 queries the vehicle assessment database 118 and matches up the vehicle ID's against insurance data to confirm evidence of insurance. The insurance verification module 113 confirms the vehicles is licensed, and if this cannot be verified, can broadcast a web services request for insurance companies to verify, as well as provide an alert to the state Department of Transportation, Department of Motor Vehicles or any other government entity via email, a service call, or a remote function call. If the query returns verification of insurance compliance, no data concerning the insurance is passed to the funds calculation module 105. If the query returns a failure to verify insurance compliance, configuration data stored at the vehicle assessment server 107 determines what actions are taken. For example, the insurance verification module 113 can be configured to pass information to the funds calculation module 105 for the calculation (and collection) of insurance fines or fees as configured, or alternatively, deny fuel access.

A program call is also made to the license verification module 114, where the driver ID is passed. The license verification module 114 runs a query against the vehicle assessment database 118 and returns license status data (406). The license verification module 114 may also query state driver's license databases and match up driver's licenses against Department of Public Safety data to confirm evidence of a valid license. The license verification module 114 confirms the driver is licensed. The license verification module 114 can also pass information to the funds calculation module 105 for the calculation of the licensing fines or fees as configured, or alternatively, deny fuel access. If the query returns verification of a valid license, no data concerning the license is passed to the funds calculation module 105. If the query returns a failure to verify license compliance, configuration data stored at the vehicle assessment server 107 determines what actions are taken. For example, a fee or a fine may be assessed as part of the funds to be collected.

A program call is also made to the fees or fines module 115, where the vehicle ID and the driver ID are passed. The fees or fines module 115 runs queries against the vehicle assessment database 118 to determine if the driver or the vehicle has any unpaid fees or fines, such as unpaid parking fines or registration fees, and returns the fee or fine status data (407). If the query returns no fines or fees due, no information concerning fees or fines are passed to the funds calculation module 105. If the query returns verification of unpaid fines or fees, configuration data stored at the vehicle assessment server 107 determines what actions are taken. For example, the unpaid fee or fines may be added to the funds to be collected.

A program call is also made to the law enforcement module 116, where the vehicle and/or driver IDs are passed. The law enforcement module 116 runs queries against the vehicle assessment database, as well as law enforcement databases, and returns law enforcement status data (408). This program call determines if the vehicle and/or the driver are being sought by law enforcement authorities in connections with any criminal activity, including car theft, Amber Alerts, suspected terrorist activity, outstanding warrants, etc. Configuration data stored at the vehicle assessment server 107 determines what actions are taken if the vehicle or the driver is sought by law enforcement. For example, access to fuel may be denied and information on the attempted transaction may be reported to law enforcement. Alternatively, fuel access can be denied or only a minimal amount of fuel required for safe transport away from the fuel retail station 301 is allowed.

The data above returned from the vehicle assessment server 107 are passed to the funds calculation module 105, which calculates the funds to be collected (409), including any tax, fees, and fines. The funds to be collected are passed to the POS system 120 via an API call or file exchange (410), which calculates the total cost of the fueling transaction and collects the total costs from the driver. The fueling transaction is thus completed (411).

The POS system 120 provides transaction data, comprising gallons pumped, the excise tax, fees and fines collected, to the taxing authority server 121 and distributes the collected funds (412). In addition, the reports module 117 of the vehicle assessment server 107 will relay reports of the captured data to interested entities, complete with analytical data this is used to provide usage and taxation reports on individual vehicles as well as aggregated information by station and geographic areas. Further, the vehicle assessment server 107 can aggregate and sort any captured data regarding driver and vehicle legal status, such as license, registration, and insurance status. Law enforcement status can also be reported, such as stolen vehicle status, criminal investigation status, Amber Alert status, and any other legal and law enforcement data collected. These reports can be utilized by the government authorities to determine tax revenues by area and graphically assess improvements in fuel efficiencies across regional areas. The data are exportable to other agencies for use in researching fuel effective behavior maturity. Other reports supplied by the vehicle assessment server 107 provide the government authority with information on tax compliance. The vehicle assessment server 107 utilizes data analytics that create profiles on thousands of vehicles in the system and provide information on vehicles whose data does not support proper tax compliance.

The POS system 120 also relays consumption and payment information via a local network system to the merchant transaction server 122 and to the oil company servers 123, as required of the retail operator.

If required, the POS system 120 may be enabled to dispense an informational summary to the driver, either in paper format or digitally via the driver's email account or through another transportation-related system, such as E-Zpass™ or FAST LANE™ systems.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for assessment of funds related to motor vehicles comprising:
(a) receiving a vehicle identification for a motor vehicle from an identification system at a fuel station as part of a fueling transaction;
(b) obtaining vehicle information and a funds calculation method from a vehicle assessment database using the vehicle identification, wherein the funds calculation method comprises variables for the vehicle information;
(c) calculating funds to be collected during the fueling transaction using the vehicle information according to the funds calculation method; and
(d) determining a total cost of the fueling transaction, the total cost comprising the funds to be collected.

2. The method of claim 1, wherein the receiving (a) and the obtaining (b) comprises:
(a1) receiving the vehicle identification by a vehicle assessment server from the identification system; and
(b1) performing a query by a vehicle identification module at the vehicle assessment server against the vehicle assessment database, wherein the query by the vehicle identification module returns the vehicle information and the funds calculation method, wherein the funds calculation method comprises the variable for the vehicle information.

3. The method of claim 2, wherein the receiving (a), obtaining (b) and the calculating (c) further comprises:
(a2) receiving a driver identification for a driver of the motor vehicle by the vehicle assessment server from the identification system;
(b2) performing a query by a social occupational module of the vehicle assessment server against the vehicle assessment database, wherein the query by the social occupational module returns driver information for the driver identification and the funds calculation method, wherein the funds calculation method further comprises variables for the driver information, wherein the driver information comprises socio-economic data for the driver; and
(c1) calculating the funds to be collected during the fueling transaction using the vehicle information and the driver information according to the funds calculation method.

4. The method of claim 3, wherein the obtaining (b) and the calculating (c) further comprises:
(b3) performing a query by an insurance verification module of the vehicle assessment server against the vehicle assessment database, wherein the query by the insurance verification module returns insurance status data for the motor vehicle or the driver and the funds calculation method, wherein the funds calculation method further comprises variables for the insurance status data; and
(c2) calculating the funds to be collected during the fueling transaction using the vehicle information, the driver information, and the insurance status data according to the funds calculation method.

5. The method of claim 4, wherein the insurance status data indicates that the motor vehicle or the driver is uninsured, wherein the calculating (c2) comprises:
(c2i) calculating the funds to be collected during the fueling transaction using the vehicle information, the driver information, and the insurance status data according to the funds calculation method, wherein the funds to be collected comprises an insurance fine or fee.

6. The method of claim 3, wherein the obtaining (b) and the calculating (c) further comprises:
(b3) performing a query by a license verification module of the vehicle assessment server against the vehicle assessment database, wherein the query by the license verification module returns license status data for the motor vehicle or the driver and the funds calculation method, wherein the funds calculation method comprises variables for the license status data; and
(c2) calculating the funds to be collected during the fueling transaction using the vehicle information, the driver information, and the license status data according to the funds calculation method.

7. The method of claim 6, wherein the license status data indicates that the motor vehicle or the driver is unlicensed, wherein the calculating (c2) comprises:
(c2i) calculating the funds to be collected during the fueling transaction using the vehicle information, the driver information, and the license status data according to the funds calculation method, wherein the funds to be collected comprises a licensing fine or fee.

8. The method of claim 3, wherein the obtaining (b) and the calculating (c) further comprises:
(b3) performing a query by a fees or fines module of the vehicle assessment server against the vehicle assessment database, wherein the query by the fees or fines module returns fees or fines data for the motor vehicle or the driver and the funds calculation method, wherein the funds calculation method comprises variables for the fees or fines data; and
(c2) calculating the funds to be collected during the fueling transaction using the vehicle information, the driver information, and the fees or fines data according to the funds calculation method.

9. The method of claim 8, wherein the fees or fines data indicates unpaid fees or fines for the motor vehicle or the driver, wherein the calculating (c2) comprises:
(c2i) calculating the funds to be collected during the fueling transaction using the vehicle information, the driver information, and the fees or fines data according to the funds calculation method, wherein the funds to be collected comprises the unpaid fees or fines.

10. The method of claim 3, wherein the obtaining (b) and the calculating (c) further comprises:
(b3) performing a query by a law enforcement module of the vehicle assessment server against the vehicle assessment database, wherein the query by the law enforcement module returns law enforcement status data for the motor vehicle or the driver and the funds calculation method, wherein the funds calculation method comprises configuration data for the law enforcement status data; and
(c2) calculating the funds to be collected during the fueling transaction using the vehicle information, the driver information, and the law enforcement status data according to the funds calculation method.

11. The method of claim 10, wherein the configuration data comprises a denial of fuel access, wherein the calculating (c) further comprises:
(c3) configuring the fueling transaction to deny fuel access.

12. The method of claim 1, further comprising:
(e) collecting funds for the total cost of the fueling transaction by a point-of-sale system; and
(f) distributing the collected funds.

13. The method of claim 1, further comprising:
(e) reporting data for the fueling transaction to one or more interested entities.

14. A system, comprising:
a vehicle assessment database; and
a vehicle assessment server operatively coupled to the vehicle assessment database, the vehicle assessment server comprising:
a processor; and
a computer readable storage medium having computer readable program code embodied therewith, the computer readable program configured to:
receive a vehicle identification for a motor vehicle from an identification system at a fuel station as part of a fueling transaction;
obtain vehicle information and a funds calculation method from the vehicle assessment database using the vehicle identification, wherein the funds calculation method comprises variables for the vehicle information;
calculate funds to be collected during the fueling transaction using the vehicle information according to the funds calculation method; and
determine a total cost of the fueling transaction, the total cost comprising the funds to be collected.

15. The system of claim 14, wherein the computer readable program code is further configured to:
receive the vehicle identification from the identification system; and
perform a query against the vehicle assessment database, wherein the query returns the vehicle information and the funds calculation method, wherein the funds calculation method comprises the variable for the vehicle information.

16. The system of claim 15, wherein the computer readable program code is further configured to:
receive a driver identification for a driver of the motor vehicle from the identification system;
perform a second query against the vehicle assessment database, wherein the second query returns driver information for the driver identification and the funds calculation method, wherein the funds calculation method further comprises variables for the driver information, wherein the driver information comprises socio-economic data for the driver; and
calculate the funds to be collected during the fueling transaction using the vehicle information and the driver information according to the funds calculation method.

17. A computer program product comprising a computer useable medium having a computer readable program, wherein the computer readable program when executed on a computer causes the computer to:
receive a vehicle identification for a motor vehicle from an identification system at a fuel station as part of a fueling transaction;
obtain vehicle information and a funds calculation method from a vehicle assessment database using the vehicle identification, wherein the funds calculation method comprises variables for the vehicle information;
calculate funds to be collected during the fueling transaction using the vehicle information according to the funds calculation method; and
determine a total cost of the fueling transaction, the total cost comprising the funds to be collected.

18. The computer program product of claim 17, wherein the computer readable program code is further configured to:
receive the vehicle identification from the identification system; and
perform a query against the vehicle assessment database, wherein the query by the vehicle identification module returns the vehicle information and the funds calculation method, wherein the funds calculation method comprises the variable for the vehicle information.

19. The computer program product of claim 18, wherein the computer readable program code is further configured to:
receive a driver identification for a driver of the motor vehicle from the identification system;
perform a second query against the vehicle assessment database, wherein the second query returns driver information for the driver identification and the funds calculation method, wherein the funds calculation method further comprises variables for the driver information, wherein the driver information comprises socio-economic data for the driver; and
calculate the funds to be collected during the fueling transaction using the vehicle information and the driver information according to the funds calculation method.
